(19) United States
(12) Patent Application Publication
(10) Pub. No.: US 2004/0124070 A1
(43) Pub. Date: Jul. 1, 2004

(54) Crescent Conveyor

(76) Inventor: Noriyasu Okoshi, Sanjo-shi (JP)

Correspondence Address: AKERMAN SENTERFITT, P.O. BOX 3188, WEST PALM BEACH, FL, 33402-3188, US

(21) Appl. No.: 10/474,772

(22) PCT Filed: Jan. 24, 2003
(86) PCT No.: PCT/JP03/00623

(30) Foreign Application Priority Data
Feb. 1, 2002 (JP) 2002-000437

(51) Int. Cl. B65G 17/22

(52) U.S. Cl. 198/850

(57) ABSTRACT

A crescent conveyer capable of reducing weight and increasing durability. The crescent conveyer includes a plurality of slat portions (1) of a nearly crescent shape in plan view and chain members (2) linking the plurality of the slat portions (1). The slat portions (1) are formed from engineering plastic such as polycarbonate and the chain members are formed from an iron-based metal such as stainless steel. The plastic slat portions (1) can realize weight saving and can reduce a motor load. The slat portions (1) and the chain members (2) that are formed from different materials are coupled by caulking members (7). The metallic chain members (2) bring about excellent strength and durability to be able to reduce possibility of producing cracks.

### BACKGROUND OF THE INVENTION

1. Technical Field

The present invention relates to a crescent conveyer.

2. Background Art

Heretofore, a conveyer of this type is disclosed by a circulation type food and drink supplying conveyer described in Japanese un-examined patent publication No. 2001-354320. In the circulation type food and drink supplying conveyer, there is provided a crescent conveyer comprising a plurality of nearly crescent-shaped slat portions and chain members linking the slat portions within a circular conveyer passage for conveying the food and drink or drinking and eating vessels.

In the crescent conveyer as mentioned above, the slat portions and the chain members which are made of a unitary material such as plastic or an iron metal member (e.g., stainless steel or the like) are popularly used. Although, the crescent conveyer formed from plastic has an advantage that it is extremely lighter as compared with that formed from an iron-metal member, circulation movement over a long-term would cause cracks and breakage failure in the chain members, and thus there have been problems of inferior life durability and endurance. When such plastic crescent conveyers are damaged, there may happen a case that the circulation movement thereof is stopped for replacing a damaged part of the crescent conveyer even in its service, and thus there is likelihood to give an obstacle to the service. Further, since the crescent conveyers formed from iron metal members are heavier than those made of plastic resin members due to the heavier components of metallic members, it is necessary to install a large-sized motor with higher torque for rotating such conveyers, and thus there has been a big problem of high production cost.

Therefore, it is an object of the present invention to provide a crescent conveyer with lighter weight and yet excellent durability.

### DISCLOSURE OF THE INVENTION

To achieve the aforementioned object, the present invention provides a food and drink supplying crescent conveyer comprising a plurality of nearly crescent-shaped slat portions in plane and chain members linking a plurality of the slat portions wherein the slat portions are formed from plastic and the chain members are formed from metal, respectively.

According to the structure described above, the plastic slat portions enable weight saving and the metallic chain members can ensure high strength, so that load of a drive unit such as a motor or the like can be decreased, while strength and endurance can be improved.

Further, the crescent conveyer of the present invention is endless and arranged annularly in plane, while the slat portions are provided so that food and drink as well as drinking and eating vessels such as dishes or the like can be put thereon and the chain members are provided below the slat portions.

According to the structure, the food and drink or the food and drink vessels such as dishes carrying food and drink thereon circulate, enabling customers to be served with them.

Furthermore, the crescent conveyer of the present invention comprises the chain members provided with rollers so that the slat portions are moved by sequential engagement of motor-driven sprockets with the rollers.

According to the structure, the drive of the motor to rotate the sprockets enables the circulation movement of the crescent conveyer.

Moreover, the crescent conveyer of the present invention comprises a drinking and eating counter arranged substantially along the crescent conveyer.

According to the structure, customers sitting at the front thereof can pick up the food and drink vessels such as dishes carrying thereon the food and drink, enabling the customers to drink and eat them.

Besides, the crescent conveyer of the present invention comprises the slat portions formed from plastic which ensures high strength and excellent endurance.

According to the structure, the slat portions can be improved in strength and weight saving.

Further, the crescent conveyer of the present invention is formed from engineering plastic, while the chain members are formed from iron metal.

According to the structure, engineering-plastic-made slat portions can be improved in weight saving and in strength, and iron-metal-made chain members can ensure high strength, thus enabling the slat portions to be improved in strength and endurance, while ensuring the strength and endurance of the chain members.

Furthermore, the crescent conveyer of the present invention comprises the slat portions and the chain members that are joined through caulking members.

According to the structure, the slat portions and the chain members that are made of different materials respectively can be fixed reliably.

Moreover, the crescent conveyer of the present invention is one where the chain members comprise a pair of upper and lower links that are spaced respectively via coupling pins, with proximal ends of the upper links being in loose contact with lower surfaces of the slat portions, and upper surfaces of distal ends of the adjacent upper links being in loose contact with the lower surfaces of the proximal ends thereof, while upper surfaces of the proximal ends of the lower links being in loose contact with the distal ends of the adjacent lower links, said coupling pins pivotably linking the upper and lower links, penetrating the upper and lower links from nearly center portions of the slat potions in a freely rotatable manner, said coupling pins being provided with rollers in a freely rotatable manner between the distal portions of the upper and lower links.

According to the structure, a pair of the upper and lower links can strengthen the chain members.

Still further, the crescent conveyer of the present invention comprises the slat portions formed from polycarbonate and the chain members formed from stainless steel.

According to the structure, the slat portions are tough and the chain members are corrosion-free.

Furthermore, the crescent conveyer of the present invention comprises the slat portions provided in a circulating conveyer passage which is installed along a drinking and eating counter, for circulating and conveying food and drink or drinking and eating vessels.

According to the structure, it is possible to convey food and drink or the drinking and eating vessels in a reliable manner along the drinking and eating counter, with the food and drink or the drinking and eating vessels being carried on the slat portions.

### BRIEF DESCRIPTION OF THE DRAWINGS

For a more complete understanding of the present invention, reference is now made to the following description taken in conjunction with the accompanying drawings, in which:

FIG. 1 is a bottom view showing an embodiment of the present invention.

FIG. 2 is a plan view showing the embodiment of the present invention.

FIG. 3 is a side view showing the embodiment of the present invention.

FIG. 4 is a perspective view showing the embodiment of the present invention.

### BEST MODE FOR CARRYING OUT THE INVENTION

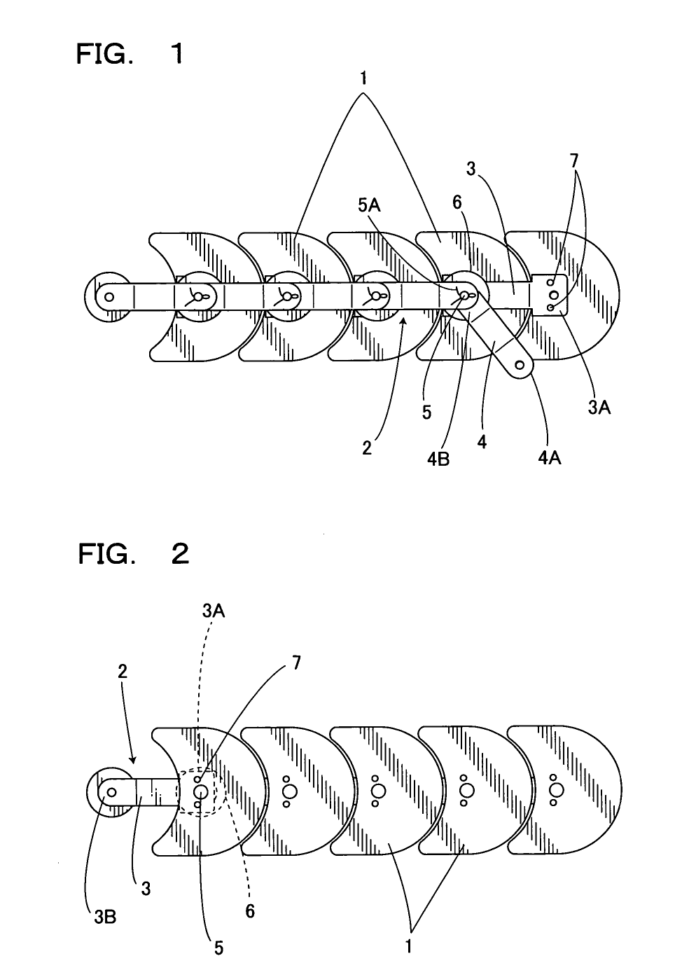

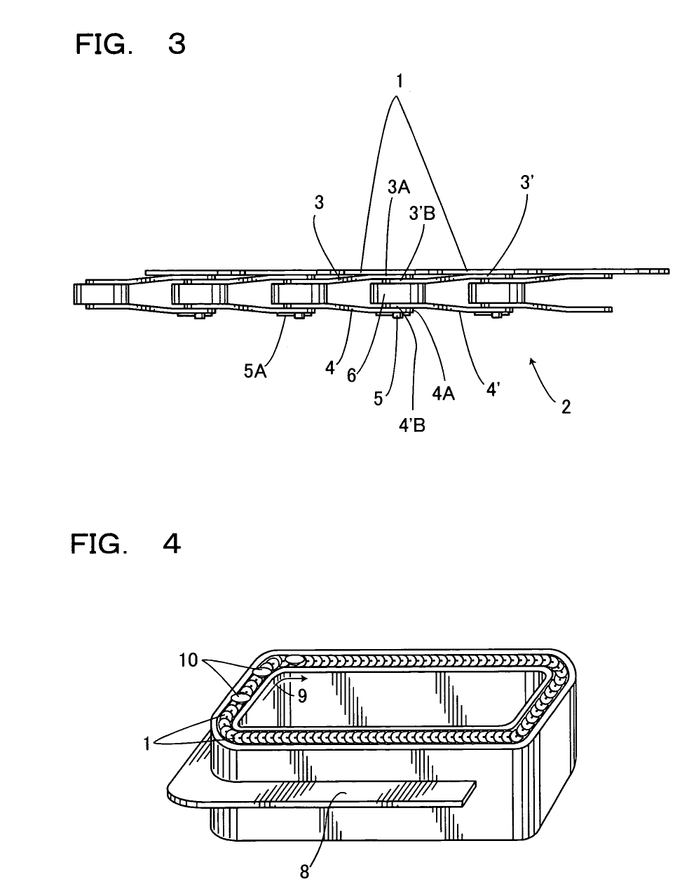

Hereunder is a description of an embodiment of the present invention with reference to the appended drawings. FIG. 1 is a bottom view showing a crescent conveyer and illustrates a lower link in an inclined manner in order to clearly show an upper link and the lower link. FIG. 2 is a plan view thereof, and FIG. 3 is a side view thereof. FIG. 4 is a perspective view illustrating an endless and circulating passage of the food and drink supplying crescent conveyer, provided along a drinking and eating table such as a counter or the like and is arranged annularly in plan view. As shown in FIG. 1, the crescent conveyer of the embodiment is provided with a plurality of slat portions 1 that are sometimes called top plates, each of which being arc-shaped at both sides with one side being concave and the other side convex, each defining approximately crescent-like plan view, and chain members 2 coupling a plurality of the slat portions. The chain members 2 comprise the upper link portions 3 and the lower link portions 4 that are vertically paired and spaced respectively via coupling pins 5. Proximal ends 3A of the upper link portions 3 are connected in loose contact with lower surfaces of the slat portions 1, while upper surfaces of the distal ends 3′B of the adjacent upper link portions 3′ are connected in loose contact with lower surfaces of the aforesaid proximal ends 3A. On the other hand, distal ends 4′B of the adjacent lower link portions 4′ are connected in loose contact with the upper surfaces of proximal ends 4A of the lower link portions 4. Further, the coupling pins 5 pivotably connect the proximal ends 3A, the distal ends 3′B, the distal ends 4′B and the proximal ends 4A, penetrating these portions from near the center of the slat portions 1. Rollers 6 are rotatably provided in the coupling pins 5, said rollers 6 being provided between the distal ends 3′B and 4′B. It should be noted that the coupling pins 5 are prevented from dropping out of the chain members 2 by means of slip-prevention pins 5A,

The slat portions 1 are formed from plastic having high strength and excellent durability such as engineering plastic, which is for example, polycarbonate or the like. Further, the upper link portions 3, the lower link portions 4 and the coupling pins 5 are formed from iron-based metal such as stainless steel, respectively. Caulking members 7 such as brass shafts or the like are inserted into through holes formed in the slat portions 1 and the proximal ends 3A of the upper link portions 3 and then they are caulked by collapsing both ends thereof, thus fixing the plastic slat portions 1 to the proximal ends 3A of the metallic upper link portions 3. The rollers 6 are formed from engineering plastic, iron-based metal or the like. The slat portions 1 as illustrated in FIG. 4 are those that are provided nearly along the drinking and eating counter 8 and are arranged endlessly along the conveyer passage 9.

Next, behavior of the aforementioned structure is described. Food or drink, or drinking and eating vessels 10 such as “sushi” dishes or the like are put on the slat portions 1. When a sprocket driven by a motor (not shown) is actuated, the rollers 6 engage sequentially with the sprocket, so that the chain members 2 and then the slat portions 1 move along the circulation conveyer passage 9. Accordingly, customers sitting at the front of the counter 8 can pick up the foods or drinks, or the drinking and eating vessels 10 such as dishes on which the foods or drinks are put, so that they are able to eat or drink them.

According to the embodiment described above, there is provided a food or drink supplying crescent conveyer comprising a plurality of the nearly crescent-shaped slat portions 1 and the chain members 2 which link a plurality of the slat portions 1, wherein the slat portions 1 are formed from plastic and the chain members 2 are formed from metal, respectively. Thus, not only can the weight saving be achieved by the plastic slat portions 1, enabling the reduction of the motor load, but also can the metallic chain members 2 ensure excellent strength and durability, decreasing the possibilities of producing cracks or the like.

Further, since the slat portions 1 are formed from engineering plastic such as polycarbonate or the like, the strength of the slat portions 1 can be ensured, so that users do not have to be concerned about the damages thereof even if the drinking and eating vessels 10 are put on the slat portions 1. Furthermore, as the chain members 2 are formed from iron-based metal such as stainless steel or the like, it is possible to ensure strength thereof, enabling the reduction of possibilities of damages thereof, so that the crescent conveyer arranged endlessly can be elongated.

Furthermore, since the slat portions 1 and the chain members 2 that are formed from different materials from each other are connected via the caulking members 7, both can be fixed reliably and simply to each other.

Moreover, since the slat portions 1 are provided in the circular conveyer passage 9 for circulating and conveying the drinking and eating vessels 10 or food and drink themselves, the operating rate of the crescent conveyer is improved so that customers can be served with food or drink constantly and securely.

It should be noted that the present invention is not limited to the aforementioned embodiment but various modifications can be possible within the scope of the gist of the present invention.

1. (Amended) A crescent conveyer for supplying food and drink, comprising: a plurality of slat portions, each slat portion being nearly crescent-shaped in plan view; and chain members linking a plurality of said slat portions, wherein said slat portions are formed from plastic while said chain members are formed from metal,
wherein said crescent conveyer is arranged in an endless and circulating manner in plan view so that food and drink or drinking and eating vessels such as dishes or the like can be put on upper surfaces of said slat portions, while said chain members are provided below said slat portions,
wherein said chain members comprise upper link portions and lower link portions that are vertically paired and spaced respectively via coupling pins such that proximal ends of the upper link portions are connected in loose contact with lower surfaces of the slat portions, while upper surfaces of distal ends of adjacent upper link portions are connected in loose contact with lower surfaces of the aforesaid proximal ends, wherein distal ends of adjacent lower link portions are connected in loose contact with the upper surfaces of said proximal ends of the lower link portions, wherein said coupling pins pivotably connect the proximal ends and the distal ends thereof, penetrating therethrough from near the center of the slat portions, while rollers are rotatably provided in said coupling pins, said rollers being provided between said distal ends, and
wherein caulking members are inserted into through holes formed in the slat portions and the proximal ends of said upper link portions and then they are caulked by collapsing both ends thereof, thus fixing the slat portions to the proximal ends of the upper link portions.

2. (canceled)

3. (Amended) A crescent conveyer according to claim 1 wherein said chain members are provided with rollers, with which sprockets driven by a motor engage sequentially, so that said slat portions move.

4. A crescent conveyer according to claim 3, wherein a drinking and eating counter is arranged nearly along said crescent conveyer.

5. A crescent conveyer according to claim 4, wherein said slat portions are formed from plastic having higher strength and excellent durability.

6. A crescent conveyer according to claim 5, wherein said slat portions are formed from engineering plastic and said chain members are formed from iron metal.

7. (canceled)

8. (canceled)

9. (canceled)

10. (canceled)

11. (New) A crescent conveyer according to claim 6, wherein said caulking members are shaft-shaped.

12. (New) A crescent conveyer according to claim 11, wherein said slat portions are formed from polycarbonate while said chain members are formed from stainless steel.

13. (New) A crescent conveyer according to claim 12, wherein said slat portions are provided in a circular conveyer passage along a drinking and eating counter for conveying drinking and eating vessels or food and drink.
